(19) United States
(12) Patent Application Publication
(10) Pub. No.: US 2008/0104033 A1
(43) Pub. Date: May 1, 2008

(54) CONTENTS SEARCHING APPARATUS AND METHOD

(75) Inventor: Keun-mi SONG, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/745,477

(22) Filed: May 8, 2007

(30) Foreign Application Priority Data
Oct. 26, 2006 (KR) 10-2006-0104689

(51) Int. Cl. G06F 7/00

(52) U.S. Cl. 707/3; 707/E17.014

(57) ABSTRACT

A contents searching apparatus and method are provided. The contents searching apparatus includes a screen forming unit which forms a screen to display search words used to search for contents on at least one shaft located at a perimeter of a three-dimensional manifold; and a controller which searches for the contents based on the at least one search word from among the displayed search words and displays the contents found on a face of the three-dimensional manifold.

### CROSS-REFERENCE TO RELATED PATENT APPLICATION

This application claims priority from Korean Patent Application No. 10-2006-0104689, filed on Oct. 26, 2006, in the Korean Intellectual Property Office, the disclosure of which is incorporated herein in its entirety by reference.

### BACKGROUND OF THE INVENTION

1. Field of the Invention

Apparatuses and methods consistent with the present invention relate to a contents searching apparatus and method, and more particularly, to a contents searching apparatus and method using a three-dimensional manifold comprising shafts and faces, thereby effectively and quickly searching for various pieces within a large amount of contents.

2. Description of Related Art

Various digital based products and new services have converged resulting in new types of products and/or services. A process known as digital convergence. Examples of digital convergence include the convergence of information such as music, data, and images, the convergence of networks such as broadcasting, communication, and the Internet, and the convergence of devices such as computers, communication devices, information devices, etc.

For example, digital televisions (DTVs) that receive a broadcasting program and provide the same can be used in connection with other digitized communication media. An Internet protocol television (IPTV) service regularly provides an information service, motion-picture contents, and broadcasting to a TV set using a high speed Internet connection. Portable multimedia players (PMPs) reproduce multimedia such as video and audio, and additionally may serve as portable communication terminals and digital cameras. Owing to the development of technology for storage media, the use of apparatuses storing a large amount of contents has increased.

Therefore, since a single device provides various types of contents and a large amount of contents, a method of effectively and quickly searching for contents desired by a user is desired.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above. The present invention provides a contents searching apparatus and method using a three-dimensional manifold comprising shafts and faces, which may effectively and quickly search for various pieces within a large amount of contents.

According to an aspect of the present invention, there is provided a contents searching apparatus comprising: a screen forming unit which forms a screen to display search words used to search for contents on at least one shaft a perimeter of a three-dimensional manifold; and a controller which searches for the contents based on at least one search word from among the displayed search words and displays found contents.

The apparatus may further provide a plurality of shafts located on the perimeter of the three-dimensional manifold and a face displayed between two adjacent shafts of the plurality of shafts.

Contents that commonly correspond to a search word selected from search words provided on two adjacent shafts may be provided to a face disposed between the two shafts from among faces of the three-dimensional manifold.

The found contents based on the search words may be provided on a face of the three-dimensional manifold in the form of a thumbnail.

An enlarged image of one or more pieces of contents from among the found contents may be provided.

The search words may comprise search words belonging to a higher class and search words belonging to a lower class corresponding to the search words belonging to the higher class.

The screen forming unit may form a screen for displaying the search words to be displayed on parts corresponding to the shafts located at the perimeter of a top view of the three-dimensional manifold in order to display the top view of the three-dimensional manifold.

The controller may control the screen forming unit to provide the search words and the found contents while the three-dimensional manifold rotates.

The search words may be generated based on a user input signal.

According to another aspect of the present invention, there is provided a contents searching method comprising: displaying search words used to search for contents on at least one shaft located at a perimeter of a three-dimensional manifold; and displaying found contents based on at least one of the displayed search words from among the displayed search words on a face of the three-dimensional manifold.

### BRIEF DESCRIPTION OF THE DRAWINGS

The above and other features of the present invention will become more apparent by describing in detail exemplary embodiments thereof with reference to the attached drawings in which:

FIG. 1 is a block diagram of a contents searching apparatus according to an exemplary embodiment of the present invention;

FIGS. 2A through 2D are diagrams illustrating contents search screens provided by the contents search apparatus illustrated in FIG. 1 according to an exemplary embodiment of the present invention;

FIGS. 3A through 3C are diagrams illustrating contents search screens provided by the contents searching apparatus illustrated in FIG. 1 according to another exemplary embodiment of the present invention;

FIG. 4 is a flowchart illustrating a contents searching method according to an exemplary embodiment of the present invention; and

FIG. 5 is a flowchart illustrating a contents searching method according to another exemplary embodiment of the present invention

### DETAILED DESCRIPTION OF THE EXEMPLARY EMBODIMENTS

The present invention will now be described more fully with reference to the accompanying drawings, in which exemplary embodiments of the invention are shown.

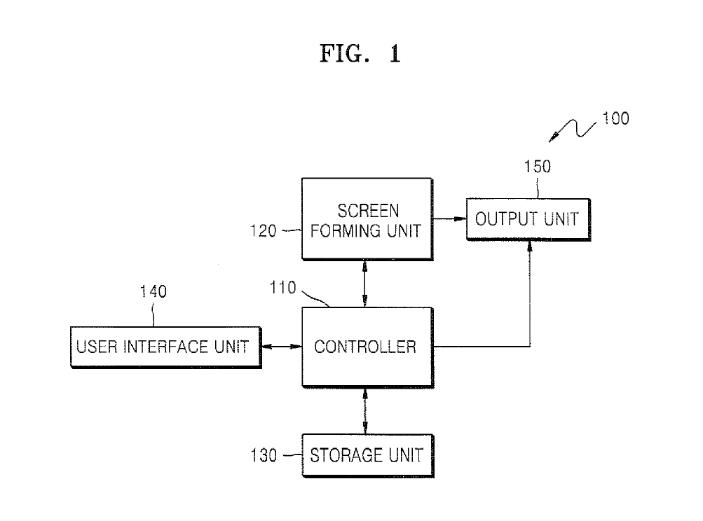

FIG. 1 is a block diagram of a contents searching apparatus 100 according to an exemplary embodiment of the present invention. Referring to FIG. 1, the contents searching apparatus 100 comprises a controller 110, a screen forming unit 120, a storage unit 130, a user interface unit 140, and an output unit 150.

The controller 110 controls communication of data between each unit included in the contents searching apparatus 100 of the present exemplary embodiment for performing a contents searching method. The controller 110 searches for contents based on one or more search words from among search words displayed on a search screen, and controls the screen forming unit 120 to display the contents found.

The screen forming unit 120 forms a screen for displaying search words used to search for contents on one or more shafts located at the perimeter of a three-dimensional manifold. In the present exemplary embodiment, contents may include multimedia contents such as audio and movie, channel information, and various pieces of broadcast program information. Therefore, search words used to search for contents may be determined according to the types of various pieces of contents. However, the present invention is not so limited and various other types of content may be searched. Accordingly, different search words may be required depending upon the type of content to be searched.

Search words that are used to search for contents include one or more search words belonging to a higher class and one or more search words belonging to a lower class corresponding to the search words belonging to the higher class. The screen forming unit 120 can form the screen so as to provide search words and the contents found when the three-dimensional manifold rotates under the control of the controller 110.

The screen forming unit 120 provides contents, which commonly correspond to a search word selected from search words provided on two shafts, to a face disposed between the two shafts from among faces of the three-dimensional manifold. A face of the three-dimensional manifold, which is provided on the search screen used to search for contents, may provide contents that are to be searched based on the search word in the form of a thumbnail.

The screen forming unit 120 provides an enlarged image of one or more pieces of contents from among the contents found. The screen forming unit 120 can form a contents search screen that further includes detailed information on contents selected from among the contents found.

The screen forming unit 120 displays search words, which are provided to search for contents on a part corresponding to a shaft located at the perimeter of a top view of the three-dimensional manifold, in order to form the screen to display the top view of the three-dimensional manifold. The top view of the three-dimensional manifold can be a circular diagram or a diagram comprising three or more lines.

The storage unit 130 stores various types of contents such as audio, video, broadcasting programs, applications providing multimedia contents, or the like. The storage unit 130 may comprise an interface that accesses and searches contents classified by search words. The storage unit 130 may have a variety of forms that allow contents corresponding to search words to be classified and searched. The contents searching apparatus 100 does not include the storage unit 130 but instead interfaces with an external storage unit to classify contents stored in the external storage unit and provide the classified contents. The user interface unit 140 receives a user input signal and transfers the user input signal to the controller 110. The user interface unit 140 can be a touch screen or a lever for a right and left and up and down input, and can be configured to receive a signal input by a remote controller and process the signal.

The search words provided to the screen forming unit 120 are previously stored in the contents searching apparatus 100 according to the types of contents in order to provide the stored search words. For example, when a user searches for audio contents, the screen forming unit 120 provides higher class search words such as genre, musicians, and album release dates, and lower class search words corresponding to the higher class search words. When the user adds a search word to the stored search words, the search word can be generated based on the user input signal through the user interface unit 140.

The output unit 150 outputs the contents search screen formed by the screen forming unit 120. When the controller 110 decodes the contents stored in the storage unit 130, the output unit 150 outputs decoded audio and video signals.

The search words provided at the shafts of the three-dimensional manifold can be changed according to the class levels of the contents to be searched. When lower class search words selected by the user input signal further include a search word belonging to the lower class, the search word belonging to the lower class of the selected lower class search words may be displayed. Thereafter, a secondary search word may be selected according to the user input signal for the search word belonging to the lower class.

For example, when contents have a higher class such as a broadcast program, movie, audio, and photo, the contents search screen displays lower class search words of the broadcast program, lower class search words of the movie, lower class search words of the audio, and lower class search words of the photo. For example, the lower class search words of the broadcast program may be displayed with a broadcast company name, genre, and first-broadcast year. If the user selects a lower class of genre, a search word of genre is displayed where a higher class search word is displayed, and a lower class search word of genre such as a soap opera, news, sports, and entertainment is provided where lower class search words are provided.

The contents searching apparatus 100 of the present exemplary embodiment may be employed in an apparatus for searching for various types of multimedia contents and reproducing the same, and providing a function of searching for multimedia contents such as DTV, IPTV, PMP, and the like. Contents search screens provided by the contents search apparatus 100 according to an exemplary embodiment of the present invention will now be described.

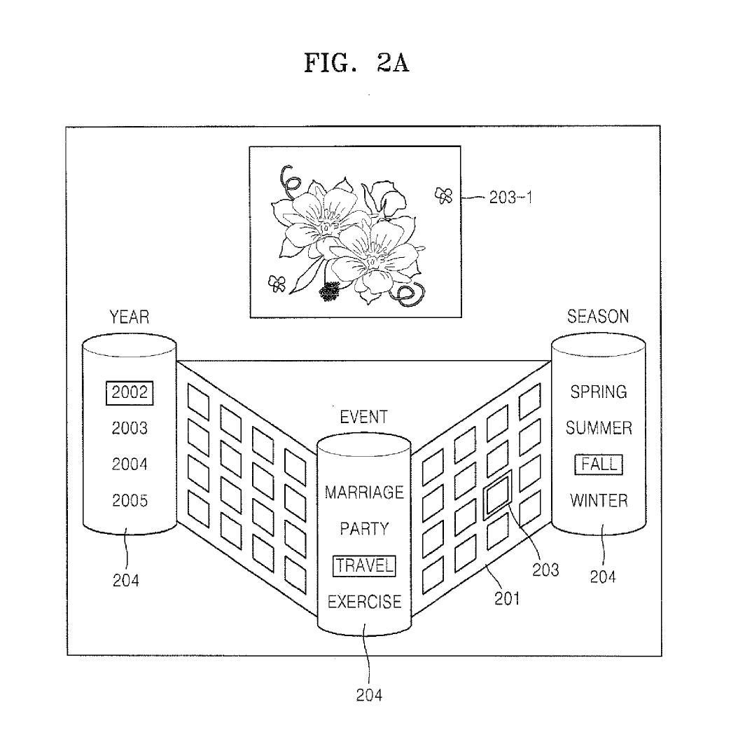

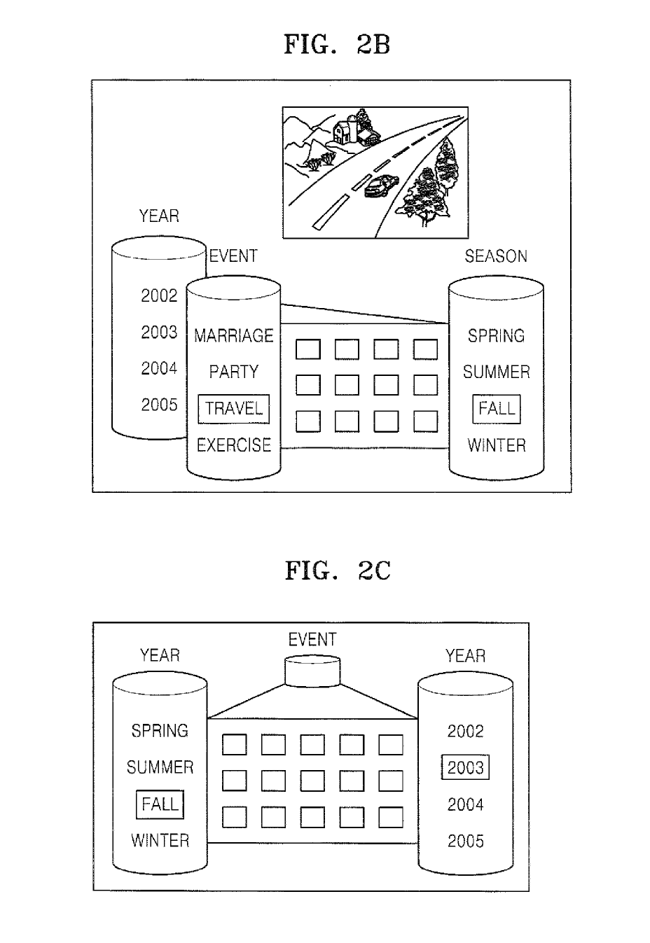

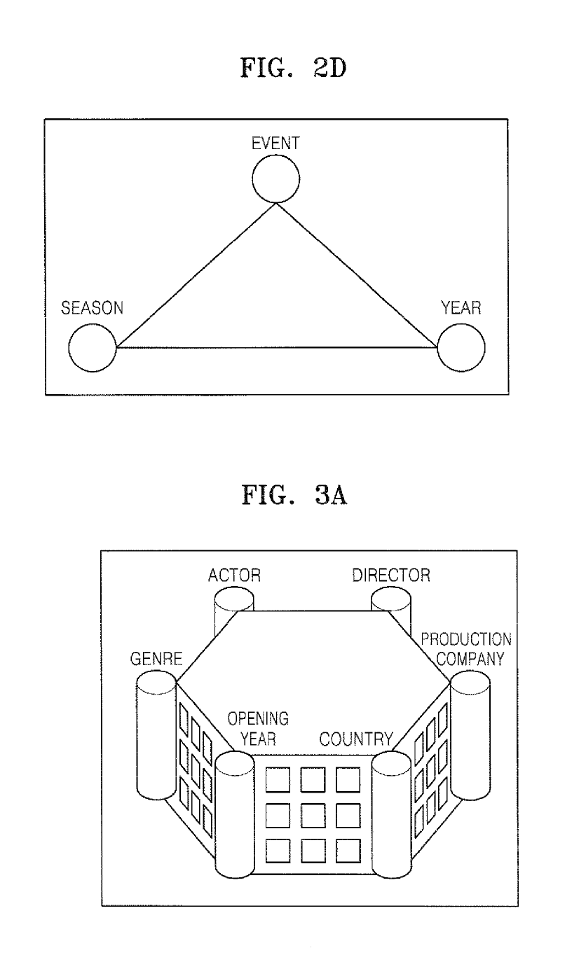

FIGS. 2A through 2D are diagrams illustrating contents search screens provided by the contents search apparatus 100 according to an exemplary embodiment of the present invention.

Referring to FIG. 2A, a contents search screen provided by the contents search apparatus 100 displays a three-dimensional manifold having three shafts 204 formed by the screen forming unit 120. For example, assume that a user is searching for image contents. The three shafts 204 of the three-dimensional manifold provide three search words of year, event, and season belonging to a higher class. The three shafts 204 provide search words belonging to a lower class corresponding to the three search words of “year”, “event”, and “season” belonging to the higher class.

In connection with the search word of “year”, lower class search words classified by the years of 2002, 2003, 2004, and 2005 are provided. In connection with the search word “event”, lower class search words of “marriage”, “party”, “travel”, and “exercise” are provided. In connection with the search word “season”, lower class search words of “spring”, “summer”, “fall”, and “winter” are provided.

A method of providing search words and the number of search words provided may be modified. For example, when a lot of search words are used to search for contents, a scroll bar type of tool can be provided on the three shafts 204 so that a user can display other search words which are not displayed due to display limitations by using a scroll bar.

A face 201 of the three-dimensional manifold provided on the search screen, which is used to search for contents, provides contents that are to be searched based on the search words in the form of a thumbnail. The screen forming unit 120 provides contents 203, which commonly correspond to one or more search words selected from among search words displayed on two shafts 204, to a face 201 disposed between the two shafts 204 from among faces of the three-dimensional manifold. The search words can be selected based on a user input signal. Contents can be searched based on a search word displayed in the highest level of lower class search words using an initial setting. If “travel” is selected from the lower class search words of event, and “fall” is selected from the lower class search words of season based on the user input signal, a face 201 disposed between the event shaft and the season shaft provides contents 203 which are classified so as to commonly correspond to “fall” and “travel”.

The screen forming unit 120 can provide an enlarged image 203-1 of one or more contents from among found contents. Therefore, if the user selects a piece of contents 203 from among contents provided on the face 201, the contents can be provided as the enlarged image 203-1.

Referring to FIG. 2B, the three-dimensional manifold included in the contents search screen illustrated in FIG. 2A is rotated through a predetermined angle. The user rotates the three-dimensional manifold provided on the contents search screen using the user interface unit 140 and, thus, allows other shafts and faces of the three-dimensional manifold to provide search words and contents.

Referring to FIG. 2C, the three-dimensional manifold included in the contents search screen illustrated in FIG. 2A is rotated to a different angle from the angle of rotation illustrated in FIG. 2B. The user rotates the three-dimensional manifold provided on the contents search screen using the user interface unit 140 and, thus, allows other shafts and faces of the three-dimensional manifold to provide search words and contents. As illustrated in FIGS. 2B and 2C, the user can search for contents using search words provided on the shafts at the perimeter of the three-dimensional manifold by rotating the three-dimensional manifold. Therefore, the user does not need to input each search word into a search window in order to search for contents.

Referring to FIG. 2D, a top view of the three-dimensional manifold is displayed on the contents search screen illustrated in FIG. 2A. The top view is in the form of a triangle. The top view of the three-dimensional manifold may comprise various shapes, for example, a circular diagram or a diagram comprising three or more lines. The contents search apparatus 100 may display search words on the contents search screen such that the top view of the three-dimensional manifold is displayed as illustrated in FIG. 2D. Displaying the three-dimensional manifold in this manner may permit the user to conveniently confirm overall search words that are used to search for contents. The higher class search words are only displayed on parts that correspond to the shafts of the perimeter of the top view of the three-dimensional manifold, but the lower class search words may also be displayed with the higher class search words.

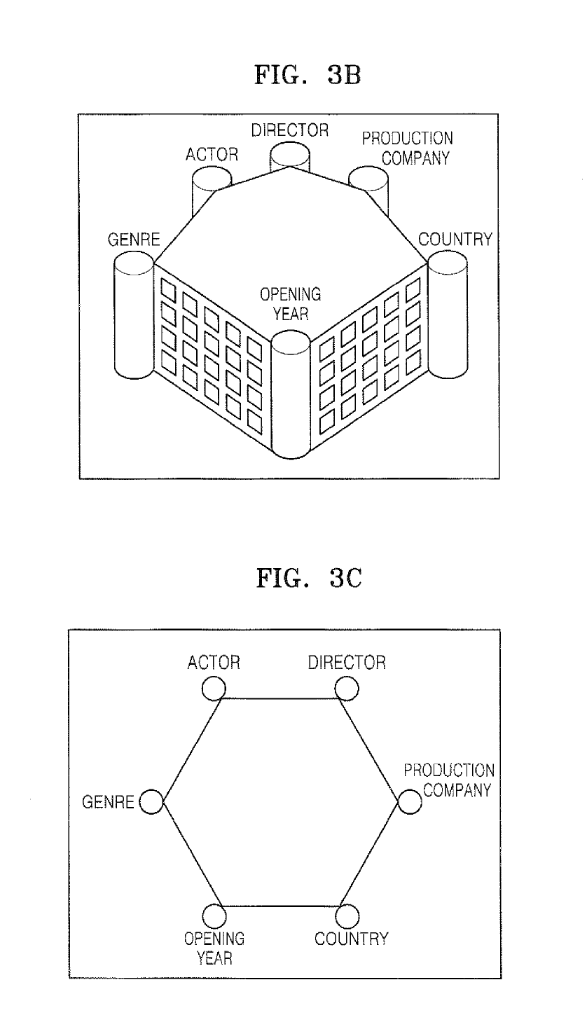

FIGS. 3A through 3C are diagrams illustrating contents search screens provided by the contents searching apparatus 100 according to another exemplary embodiment of the present invention.

Referring to FIG. 3A, a contents search screen provided by the contents search apparatus 100 displays a three-dimensional manifold having six shafts formed by the screen forming unit 120. In this exemplary embodiment, for example, a user searches for a movie. The six shafts of the three-dimensional manifold provide six search words of “opening year”, “country”, “production company”, “director”, “actor”, and “genre” belonging to a higher class adjacent to the six shafts of the three-dimensional manifold.

Although not shown in FIG. 3A, the six shafts may provide search words belonging to a lower class corresponding to the six search words of “opening year”, “country”, “production company”, “director”, “actor”, and “genre” belonging to the higher class as illustrated in FIG. 2A. A face of the three-dimensional manifold provided on the contents search screen, which is used to search for contents, provides contents that are to be searched based on the search words in the form of a thumbnail.

Referring to FIG. 3B, the three-dimensional manifold included in the contents search screen illustrated in FIG. 3A is rotated through a predetermined angle. The user may rotate the three-dimensional manifold provided on the contents search screen using the user interface unit 140 and, thus, allows other shafts and faces of the three-dimensional manifold to provide search words and contents.

Referring to FIG. 3C, a top view of the three-dimensional manifold is displayed on the contents search screen illustrated in FIG. 3A. The top view is a hexagon. The contents search apparatus 100 displays search words on the contents search screen that displays the top view of the three-dimensional manifold illustrated in FIG. 3C so that the user may conveniently confirm the overall search words used to search for contents. In this illustration, the higher class search words are displayed on parts that correspond to the shafts of the perimeter of the top view of the three-dimensional manifold, but the lower class search words may be displayed with the higher class search words.

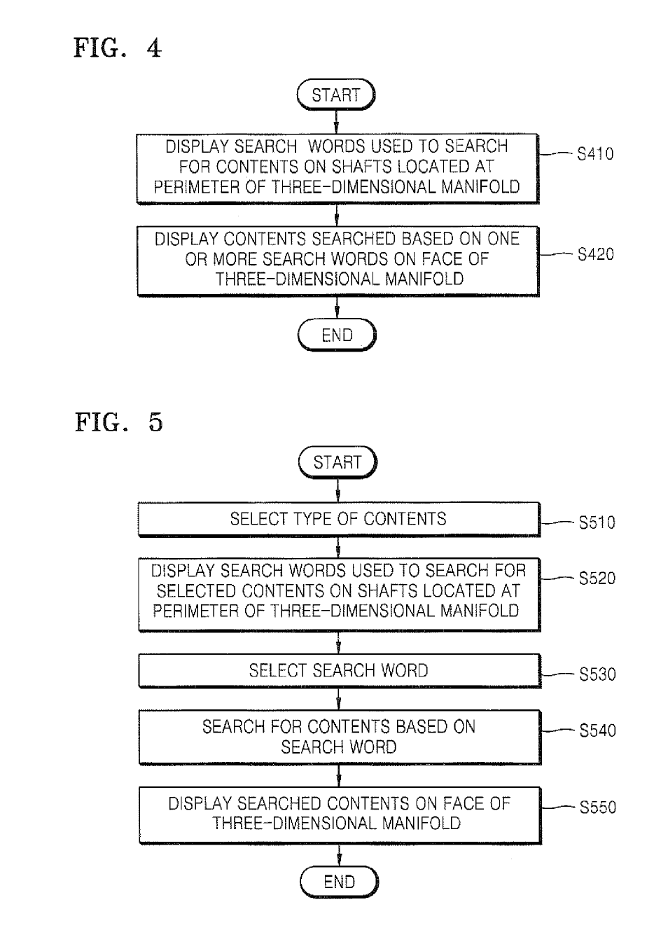

FIG. 4 is a flowchart illustrating a contents searching method according to an exemplary embodiment of the present invention. Referring to FIG. 4, search words used to search for contents are displayed on shafts located at the perimeter of a three-dimensional manifold (Operation S410). The shafts provide search words belonging to a higher class and search words belonging to a lower class corresponding to the search words belonging to the higher class.

A face of the three-dimensional manifold displays contents found based on one or more search words (Operation S420).

A face disposed between two shafts among the shafts of the three-dimensional manifold may provide contents that commonly correspond to one or more search words selected from search words displayed on the two shafts. A face of the three-dimensional manifold may provide contents, which are found based on the search words, in the form of a thumbnail. An enlarged image of one or more contents from among found contents may also be provided. When a screen is formed in order to display a top view of the three-dimensional manifold, the search words provided to search for contents may be displayed on parts corresponding to shafts located at the perimeter of the top view of the three-dimensional manifold. The top view of the three-dimensional manifold may be a circular diagram or a diagram comprising three or more lines.

FIG. 5 is a flowchart illustrating a contents searching method according to another exemplary embodiment of the present invention. Referring to FIG. 5, the type of contents is selected according to a user input signal (Operation S510). For example, the type of contents can be selected from audio, video, photo, and broadcast program.

A contents searching apparatus displays search words used to search for contents belonging to the selected type of contents on shafts located at the perimeter of a three-dimensional manifold (Operation S520). The shafts provide one or more search words belonging to a higher class and search words belonging to a lower class corresponding to the search words belonging to the higher class. In Operation S520, a user input signal requesting the rotation of the three-dimensional manifold may be received and the three-dimensional manifold rotated based on the user input signal so as to provide the search words.

A search word is selected by the user using user input signals from among the search words displayed on a contents search screen (Operation S530).

Contents are searched based on the selected search word (Operation S540).

The found contents are displayed on a face of the three-dimensional manifold (Operation S550). A face disposed between two shafts among faces of the three-dimensional manifold may provide contents that commonly correspond to one or more search words selected from search words displayed on the two shafts. The contents provided on the face of the three-dimensional manifold may also be in the form of a thumbnail. An enlarged image of one or more contents from among found contents may also be provided.

The present invention may also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed network coupled computer systems so that the computer readable code is stored and executed in a distributed fashion.

According to the various exemplary embodiments of the present invention, a contents searching apparatus and method that effectively select a search word used to search for contents using shafts and faces of a three-dimensional manifold and provide found contents using the selected search word, so that a user may effectively and quickly search for various pieces of huge amounts of contents. Since the user may search for contents using search words provided on the shafts at the perimeter of the three-dimensional manifold by rotating the three-dimensional manifold, the user does not need to input each search word.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A contents searching apparatus comprising:
a screen forming unit which forms a screen to display search words used to search for contents, on at least one shaft located at a perimeter of a three-dimensional manifold; and
a controller which searches for the contents based on at least one search word from among the displayed search words and displays contents found.

2. The apparatus of claim 1, further comprising:
a plurality of shafts located on the perimeter of the three-dimensional manifold; and
a face displayed between two adjacent shafts of the plurality of shafts.

3. The apparatus of claim 2, wherein contents that commonly correspond to a search word selected from search words provided on the two adjacent shafts are provided to the face.

4. The apparatus of claim 2, wherein the contents found based on the at least one search word are provided on the face as a thumbnail.

5. The apparatus of claim 2, wherein an enlarged image of one of the contents found is displayed on the screen.

6. The apparatus of claim 1, wherein the search words comprise higher class search words and lower class search words,
wherein lower class search words correspond to higher class search words.

7. The apparatus of claim 2, wherein the screen forming unit forms the screen such that the search words are displayed adjacent to the shafts and a top view of the three-dimensional manifold is displayed.

8. The apparatus of claim 2, wherein the controller controls the screen forming unit to display the search words and the contents found while the three-dimensional manifold rotates.

9. The apparatus of claim 1, wherein the search words are generated based on a user input signal.

10. The apparatus of claim 8, wherein the controller controls a rotation of the three-dimensional manifold based on a user input signal.

11. A contents searching method comprising:
displaying search words used to search for contents, on at least one shaft located at a perimeter of a three-dimensional manifold; and
displaying found contents based on at least one of the displayed search words.

12. The method of claim 11, further comprising:
displaying a plurality of shafts located on the perimeter of the three-dimensional manifold; and
displaying the found contents on a face displayed between two adjacent shafts of the plurality of shafts.

13. The method of claim 12, wherein contents that commonly correspond to a search word selected from search words provided on the two adjacent shafts are displayed on the face.

14. The method of claim 12, wherein the found contents based on the at least one of the displayed search words are provided on the face of the three-dimensional manifold as a thumbnail.

15. The method of claim 11, further comprising: providing an enlarged image representing one of the found contents.

16. The method of claim 11, wherein the search words comprise higher class search words and lower class search words,
wherein one lower class search words correspond to higher class search words.

17. The method of claim 11, further comprising: displaying a top view of the three-dimensional manifold and displaying the search words adjacent to the shafts located at the perimeter.

18. The method of claim 11, further comprising: displaying the search words and the found contents while the three-dimensional manifold rotates.

19. The method of claim 11, further comprising: generating the displayed search words based on a user input signal.

20. A computer readable recording medium having embodied thereon a computer program for executing a contents searching method, the method comprising:
displaying search words used to search for contents on at least one shaft located at a perimeter of a three-dimensional manifold; and
displaying found contents based on at least one of the displayed search words on a face of the three-dimensional manifold adjacent to the at least one shaft.
